(19) United States
(12) Patent Application Publication
(10) Pub. No.: US 2022/0007561 A1
(43) Pub. Date: Jan. 13, 2022

(54) AN AGRICULTURAL WORK VEHICLE

(71) Applicant: Agro Intelligence ApS, Aarhus N (DK)

(72) Inventors: Jacob Pilegaard Juul, Skanderborg (DK); Liubava Znova, Tilst (DK); Henrik Lynge Jacobsen, Hàrlev (DK); Claus Dühring Jæger, Skanderborg (DK); Martin Boel, Aarhus (DK); Jørgen Tjagvad Bendix, Malling (DK)

(73) Assignee: Agro Intelligence ApS, Aarhus N (DK)

(21) Appl. No.: 17/297,447

(22) PCT Filed: Nov. 18, 2019
(86) PCT No.: PCT/DK2019/050355

§ 371 Date: May 26, 2021

(30) Foreign Application Priority Data
Nov. 27, 2018 (DK) PA 2018 00916

(51) Int. Cl. A01B 51/02; A01B 75/00

(52) U.S. Cl. CPC A01B 51/023; A01B 75/00

(57) ABSTRACT

The invention relates to an agricultural work vehicle (100) for performing an agricultural work operation in an agricultural field, wherein said work vehicle comprises:
a first drive module (2); a second drive module (4); a connecting element (6); said connecting element comprises a first axial end (8) and a second axial end (10); propulsion means (12) for propelling said work vehicle; steering means (14) for steering said work vehicle; a control unit (16) for controlling the operation of said work vehicle;
   wherein said first drive module (2) comprises a first chassis (18); wherein said second drive module (4) comprises a second chassis (20); wherein said first drive module (2) comprises drive means (90) for allowing said first drive module to move over ground, said drive means (90) being suspended on said first chassis (18); wherein said second drive module comprises drive means (92) for allowing said second drive module to move over ground, said drive means (92) being suspended on said second chassis (20); wherein said first axial end (8) of said connecting element (6) is being attached to said first chassis (18); and wherein said second axial end (10) of said connecting element (6) is being connected to said second chassis (20);
   wherein one of said two drive modules (2,4) comprises a load carrying platform (26) arranged at the corresponding chassis (18,20)
   wherein said agricultural work vehicle (100) is being an autonomous work vehicle; and
   wherein said load carrying platform (26) is being integrated with said second chassis (20) of said second drive module (4);
   wherein said first axial end (8) of said connecting element (6) is attached to said first chassis (18) of said first drive module (2) at an end thereof; and wherein said second axial end (10) of said connecting element (6) is attached to said second chassis (20) of said second drive module (4) at an end thereof.

### FIELD OF THE INVENTION

The present invention relates in general to the field of agriculture. More specifically the present invention relates in a first aspect to an agricultural work vehicle for performing an agricultural work operation. In a second aspect the present invention relates to a use of an agricultural work vehicle according to the first aspect for performing an agricultural work operation.

### BACKGROUND OF THE INVENTION

Within the field of agriculture, it has traditionally been common practice to provide auxiliary power when performing agricultural work, such as during tillage. Such auxiliary power had for centuries been provided by relatively large animals, such as cattle, horses, donkeys etc.

During the 1940s and the 1950 the use of tractors for aiding soil working became very popular and tractors eventually outperformed the use of towing animals.

Tractors provide many benefits compared to use of work animals. These benefits comprise inter alia increased power, no exhaustion during prolonged working periods, full obedience to the operator's instructions etc.

Because tractors are manually operated, thus needing an operator during use thereof, it makes sense that tractors are designed with the current relatively large size. The rationale is: because a tractor needs a human operator, tractors might just as well be designed in a size that allows working a relatively large width of agricultural soil, thereby reducing the time needed for human interference. Hence, it is not uncommon that currently produced tractors are having sizes that allows for working the agricultural field in a width of 1-50 meters or more.

Although the rather large sizes of currently produced tractors provide for efficient working of an agricultural field, these tractors nevertheless present a number of disadvantages.

One of these disadvantages is that the large size of these tractors and the accompanying high weight imposes a not insignificantly soil compaction. Any soil compaction is undesirable because it prevents optimal growth conditions of crops growing in the soil or to crops to be sown in the soil.

The larger the machines becomes, the more difficult it is for the human operator to apply the needed attention to the individual square meter of the field. Hence the fields therefore are being managed more according to a plan and not to the site-specific conditions and needs.

With the recent advances of robot technology, autonomous agricultural working vehicles (or autonomous agricultural robots) have been developed. Such autonomous agricultural work vehicles may be able to perform tillage operations, spraying operations, seeding operations, weeding operations and other types of agricultural operations.

Additionally, such robots are particularly well suited for performing sensor-based surveying of an agricultural field with the view to gain information of the general state of such field, the soil and its crops.

These agricultural robots may be programmed to follow a predetermined path in the agricultural field upon working it but can also be equipped with a system for adaptive route planning for in-field optimization of the specific operation, thereby avoiding the necessity of human intervention during its operation.

As such robots are autonomous and therefore does not require human operation during the working thereof, it is not a decisive factor to design the robots in a size that has the same working capacity as the currently available tractors in order to maintain a competitive cost-efficient operation.

One type of an agricultural robot has been manufactured and marketed by the proprietor of the present application, under the trade name “Robotti”.

Robotti comprises two drive modules with wheels, arranged sideways relative to the direction of movement. Each of the two drive modules are rigidly fixed to opposite ends of a front bar having a fixed axial extension. On the front bar, between the two drive modules, is arranged a three-point linkage which allows an agricultural implement to be coupled to the front bar of Robotti.

Each drive module comprises two broad wheels arranged behind one another. Each wheel comprises a hub including a hydraulic drive. Both of the drive modules comprise a diesel engine coupled to a hydraulic pump which provides pressurized hydraulic fluid to be supplied to the hydraulic drives of the wheels.

A control system provides for controlling Robotti. The control system is being configured to control the movement of Robotti according to the operational specifications to be followed.

With the relative low weight of Robotti, its broad wheels and tires, Robotti imparts considerably less soil compaction to the soil, compared to the situation encountered by conventional tractors.

However, although Robotti represents huge advances in the field of agriculture, this robot nevertheless leaves room for improvement.

One of these disadvantages is that prior art Robotti work vehicle is having engines, hydraulics, and fuel tanks, batteries etc. arranged in each individual drive module. Thereby, in respect of both the drive modules, no free space is available near the level of the chassis of the drive modules. Accordingly, the prior art Robotti work vehicle is not in itself capable of transporting lose loads, such as solutions for chemical sprayers, fertilizers for fertilizer equipment and seeds for seed drills.

The prior art Robotti also represents limitations due to its height in e.g. a harvest operation involving sideways offload to a transport vehicle during movement is required. Such harvesting operations may be harvesting of grass, potatoes or other vegetables.

Accordingly, a need exists for an improved autonomous agricultural work vehicle which overcomes the above identified disadvantage.

It is an objective of the present invention to provide an improved agricultural work vehicle which overcomes the above listed disadvantage.

### BRIEF DESCRIPTION OF THE INVENTION

This objective is fulfilled according to the first and the second aspect of the present invention.

Accordingly, the first aspect of the present invention relates to an agricultural work vehicle for performing an agricultural work operation in an agricultural field, wherein said work vehicle comprises:
a first drive module;
a second drive module;
a connecting element; said connecting element comprises a first axial end and a second axial end;
propulsion means for propelling said work vehicle;
steering means for steering said work vehicle;
a control unit for controlling the operation of said work vehicle;

wherein said first drive module comprises a first chassis;

wherein said second drive module comprises a second chassis;

wherein said first drive module comprises drive means for allowing said first drive module to move over ground, said drive means being suspended on said first chassis;

wherein said second drive module comprises drive means for allowing said second drive module to move over ground, said drive means being suspended on said second chassis;

wherein said first axial end of said connecting element is being attached to said first chassis; and wherein said second axial end of said connecting element is being connected to said second chassis;

wherein one of said two drive modules comprises a load carrying platform arranged at the corresponding chassis.

In a second aspect the present invention relates to the use of an agricultural work vehicle according to the first aspect for performing an agricultural work operation.

The present invention in its various aspects provides for improved flexibility, compared to the prior art Robotti work vehicle in that the agricultural work vehicle of the present invention provides for allowing transporting rather large and heavy loads. This feature is beneficial in various agricultural situations, such as transportation of water or solutions for sprayers, fertilizers for fertilizer equipment and seeds for seed drills.

Furthermore, the inventive work vehicle allows sideways offload to a transport vehicle during movement in a harvesting operation. Such harvesting operations may be harvesting of grass, potatoes or other vegetables.

### BRIEF DESCRIPTION OF THE FIGURES

FIG. 1a is a perspective view illustrating an agricultural work vehicle according to the prior art.

FIG. 1b is a perspective view illustrating an agricultural work vehicle according to the prior art, with its covers removed.

FIG. 2a is a perspective view illustrating an agricultural work vehicle according to the present invention.

FIG. 2b is a top view illustrating the inventive agricultural work vehicle shown in FIG. 2a.

FIG. 2c is a front view illustrating the inventive agricultural work vehicle shown in FIG. 2a.

FIG. 2d is a side view inventive agricultural work vehicle shown in FIG. 2a.

FIG. 2e is a is a perspective view illustrating an agricultural work vehicle according to the present invention with its cover removed.

FIG. 3 is a schematic diagram illustrating the principle of the working mode of the control unit of the agricultural work vehicle of the present invention.

### DETAILED DESCRIPTION OF THE INVENTION

The First Aspect of the Present Invention

The first aspect of the present invention relates to an agricultural work vehicle for performing an agricultural work operation in an agricultural field, wherein said work vehicle comprises:
a first drive module;
a second drive module;
a connecting element; said connecting element comprises a first axial end and a second axial end;
propulsion means for propelling said work vehicle;
steering means for steering said work vehicle;
a control unit for controlling the operation of said work vehicle;

wherein said first drive module comprises a first chassis;

wherein said second drive module comprises a second chassis;

wherein said first drive module comprises drive means for allowing said first drive module to move over ground, said drive means being suspended on said first chassis;

wherein said second drive module comprises drive means for allowing said second drive module to move over ground, said drive means being suspended on said second chassis;

wherein said first axial end of said connecting element is being attached to said first chassis; and wherein said second axial end of said connecting element is being connected to said second chassis;

wherein one of said two drive modules comprises a load carrying platform arranged at the corresponding chassis.

It should be noted that in the present description and in the appending claims it is understood that generally the one drive module which comprises the load carrying platform may either be the left drive module or the right drive module (when viewed in a driving direction where the connecting element is facing the driving direction). However, there may be situations in which it is preferred that the load carrying platform is arranged specifically at the right hand drive module or at the left hand drive module.

Accordingly, depending of specific needs, the inventive agricultural work vehicle may be designed in either geometry.

In an embodiment of the agricultural work vehicle according to the first aspect of the present invention the agricultural work vehicle is being a remotely controlled work vehicle and/or an autonomous work vehicle and/or a semi-autonomous work vehicle.

Hereby is achieved that the agricultural operation can be performed remotely controlled, autonomous or semi-autonomous. In the present description and in the appended claims a semi-autonomous mode shall be construed to mean an autonomous mode in which an operator may overrule autonomy by remotely providing remote and manual operational instructions during its autonomous operation.

In an embodiment of the agricultural work vehicle according to the first aspect of the present invention the propulsion means comprises one or more electric motors or one or more hydraulic drives or one or more mechanical drives for driving said drive means.

These types of propelling the work vehicle have proven beneficial.

In an embodiment of the agricultural work vehicle according to the first aspect of the present invention the drive means each comprises two or more sets of wheels, wherein all wheels in a specific set of wheels are sharing a common axis of rotation; or wherein said drive means each comprises one or two or more caterpillar belts.

Wheels and caterpillar belts have proved simple and cost efficient way of propelling the agricultural work vehicle.

In an embodiment of the agricultural work vehicle according to the first aspect of the present invention the drive means each comprises two sets of wheels, said sets of wheels being arranged behind each other, as seen relative to a non-turning direction of movement of said vehicle.

In an embodiment of the agricultural work vehicle according to the first aspect of the present invention the set of wheels, in respect of a specific set of wheels, comprises one, two, three, or four or more wheels.

In an embodiment of the agricultural work vehicle according to the first aspect of the present invention the drive means comprises one, two, three, or four or more caterpillar belts, optionally being arranged sideways to each other and/or behind each other.

In an embodiment of the agricultural work vehicle according to the first aspect of the present invention the propulsion means are configured for driving one or two sets of wheels or caterpillar belts of each drive module.

In an embodiment of the agricultural work vehicle according to the first aspect of the present invention the propulsion means comprises hydraulic drives for driving said drive means and the agricultural work vehicle comprises one or more hydraulic pumps for driving said hydraulic drives, and the agricultural work vehicle furthermore comprises a motor for driving the hydraulic pump, such as an electric motor; or a combustion engine, such as a petrol engine or a diesel engine, or a biogas engine.

In an embodiment of the agricultural work vehicle according to the first aspect of the present invention the propulsion means comprises an electric motor for driving said drive means.

In an embodiment of the agricultural work vehicle according to the first aspect of the present invention the propulsion means comprises mechanical means for driving said drive means.

In these three embodiments the agricultural work vehicle may be propelled using hydraulic, electric or mechanic technology.

In an embodiment of the agricultural work vehicle according to the first aspect of the present invention one or more of said wheels independently is/are having an outer diameter of 25-300 cm, such as 30-275 cm, for example 35-250 cm, such as 40-225 cm, e.g. 45-200 cm, such as 50-175 cm, e.g. 55-150 cm, such as 60-125 cm, e.g. 65-100 cm, such as 70-95 cm, such as 75-90 cm, e.g. 80-85 cm.

In some environments it is preferably to provide the agricultural work vehicle with wheels having a relatively large diameter and in other environments it is preferably to the agricultural work vehicle with smaller wheels. The above ranges cover most situations.

In an embodiment of the agricultural work vehicle according to the first aspect of the present invention at least one set of wheels of each drive module is being pivotally suspended in a wheel base on its corresponding chassis in such a way that the pitch of the rotational plane of said one or more wheels of said set of wheels can be altered, relative to a fixed geographical direction, and wherein said steering means comprises actuation means for altering said pitch.

This design provides for a reliable mode of steering the agricultural work vehicle. In an embodiment of the agricultural work vehicle according to the first aspect of the present invention the steering means comprises means for allowing propelled wheels of one drive module to rotate at a rotational speed which is different from the rotational speed of the propelled wheels of the other drive module.

This design provides for another reliable mode of steering the agricultural work vehicle. In certain embodiments the above two steering modes may be combined. In an embodiment of the agricultural work vehicle according to the first aspect of the present invention the shortest distance from the center of a wheel of one drive module to the center of a wheel of the other drive module is selected from the range 20-4000 cm, such as 30-3500 cm, e.g. 40-3000 cm, such as 50-2500 cm, for example 60-2000 cm, e.g. 70-1800 cm, such as 80-1700 cm, e.g. 90-1600 cm, for example 100-1500 cm, e.g. 150-1400 cm, e.g. 200-1300 cm, such as 250-1200 cm, such as 300-1100 cm, such as 350-1000 cm, such as 400-900 cm, such as 500-800 cm, e.g. 600-700 cm.

The above widths of the agricultural work vehicle have proven appropriate for the intended purpose of performing an agricultural operation.

In an embodiment of the agricultural work vehicle according to the first aspect of the present invention the work vehicle further is comprising an energy storage or energy provider, such as a fuel tank or a battery; or one or more solar panels; or one or more fuel cell modules in combination with a fuel gas tank, such as a hydrogen tank or a methane tank.

These energy sources have proven beneficial for a work vehicle according to the first aspect of the invention.

In an embodiment of the agricultural work vehicle according to the first aspect of the present invention the work vehicle further comprising coupling means for allowing coupling to said agricultural work vehicle of an agricultural implement, said coupling means optionally being arranged at or on said connecting element, said coupling means optionally being in the form of a three-point hitch or in the form of an A-frame.

In an embodiment of the agricultural work vehicle according to the first aspect of the present invention the first drive module and said second drive module are having an elongate shape.

It has proved beneficial to design each drive module with an elongate shape having its longest dimension in the driving direction.

In an embodiment of the agricultural work vehicle according to the first aspect of the present invention the first axial end of said connecting element is attached to said first chassis of said first drive module at an end thereof; and wherein said second axial end of said connecting element is attached to said second chassis of said second drive module at an end thereof.

Hereby the connecting element will be arranged near an extreme end of the agricultural work vehicle.

In an embodiment of the agricultural work vehicle according to the first aspect of the present invention the first drive module and said second drive module are arranged essentially in a parallel orientation relative to each other.

In an embodiment of the agricultural work vehicle according to the first aspect of the present invention the first drive module and said second drive module are arranged relative to each other in such a way that a free space is being present between part of said first drive module and part of said second drive module.

Hereby is assured that there is providing room for an agricultural implement in the free space between the drive modules.

In an embodiment of the agricultural work vehicle according to the first aspect of the present invention the free space between the first drive module and the second drive module in a region appearing in a direction perpendicular to the connecting element, such as in a forward pointing direction and/or in a rearward pointing direction, is devoid from any element connecting said first drive module to said second drive module.

Hereby is assured that no elements prevent or impair the operation of an agricultural implement being arranged between the two drive modules.

In an embodiment of the agricultural work vehicle according to the first aspect of the present invention each drive means is being rigidly suspended at or on its corresponding chassis, i.e. in a non-spring-loaded manner.

By providing the pivoting means as defined according to the first aspect of the present invention, expenses for manufacturing spring-loaded suspensions of the drive means can be avoided altogether, thereby reducing manufacturing costs.

Alternatively, each drive means may be suspended at or on its corresponding chassis in a spring-loaded manner.

In an embodiment of the agricultural work vehicle according to the first aspect of the present invention the work vehicle comprises a monitoring unit for visually monitoring soil and/or vegetation during operation thereof.

Hereby the agricultural work vehicle according to the first aspect of the present invention can be used for surveying operations in an agricultural field.

In an embodiment of the agricultural work vehicle according to the first aspect of the present invention the work vehicle comprises means for allowing, during driving a curved trajectory, the outer drive means, such as the outer wheels, to rotate a higher angular velocity, compared to the inner drive means, such as the inner wheels.

Hereby a minimum degree of adverse physical impact is imposed to the soil.

In an embodiment of the agricultural work vehicle according to the first aspect of the present invention the part of the propulsion means providing the power for propelling said agricultural work vehicle is being solely arranged on said first drive module.

Hereby can be s assured that there will be enough free space at the second drive module so as to allow arranging the load carrying platform at the second drive module.

In an embodiment of the agricultural work vehicle according to the first aspect of the present invention the control unit is being solely arranged at said first drive module.

Hereby can be s assured that there will be enough free space at the second drive module so as to allow arranging the load carrying platform at the second drive module.

In an embodiment of the agricultural work vehicle according to the first aspect of the present invention any energy storage or energy provider, such as a fuel tank or a battery; or one or more solar panels; or one or more fuel cell modules in combination with a fuel gas tank, such as a hydrogen tank or a methane tank, is/are being solely arranged at said first drive module.

Hereby can be s assured that there will be enough free space at the second drive module so as to allow arranging the load carrying platform at the second drive module.

In an embodiment of the agricultural work vehicle according to the first aspect of the present invention the load carrying platform defines an upper surface having an extension in a longitudinal direction of 100-4000 cm, such as 150-3500 cm, e.g. 200-3000 cm, for example 250-2500 cm, such as 300-2000 cm, e.g. 400-1500 cm, e.g. 500-1000 cm.

In an embodiment of the agricultural work vehicle according to the first aspect of the present invention the load carrying platform comprises an upper surface having an extension in a transverse direction of 25-1500 cm, such as 50-1200 cm, e.g. 100-1000 cm, such as 150-800 cm, e.g. 200-700 cm, such as 300-600 cm or 400-500 cm.

These dimensions of the load carrying platform have proven beneficial for the purpose of carrying loads in an agricultural field.

In an embodiment of the agricultural work vehicle according to the first aspect of the present invention the load carrying platform defines an upper surface which is being arranged at a level above ground of 20-200 cm, such as 25-175 cm, e.g. 50-150 cm, such as 75-125 cm.

The lower height at which the load carrying platform is arranged, the easier it will be to handle loads arranged thereon. The listed dimensions have proven suitable.

In an embodiment of the agricultural work vehicle according to the first aspect of the present invention the load carrying platform is being arranged at a level above said drive means of said second drive module.

Hereby the work vehicle takes up a minimum of space in the horizontal plane.

In an embodiment of the agricultural work vehicle according to the first aspect of the present invention the load carrying platform is being arranged above said second chassis of the second drive module; or wherein said load carrying platform is integrated with said second chassis of said second drive module.

In an embodiment of the agricultural work vehicle according to the first aspect of the present invention the load carrying platform defines an upper surface having a rectangular shape.

A rectangular shape is a common shape for a load carrying platform employed in the field of transportation and agriculture.

In an embodiment of the agricultural work vehicle according to the first aspect of the present invention the load carrying platform comprises one or more essentially vertical sides, such as detachable sides, for securing goods being arranged on said platform.

Hereby goods being carried can be prevented from falling off the load carrying platform.

In an embodiment of the agricultural work vehicle according to the first aspect of the present invention the second drive module is devoid of any of the following: the part of the propulsion means providing the power for propelling said agricultural work vehicle; said control unit; any energy storage or energy provider, such as a fuel tank or a battery; or one or more solar panels; or one or more fuel cell modules in combination with a fuel gas tank, such as a hydrogen tank or a methane tank.

Hereby can be s assured that there will be enough free space at the second drive module so as to allow arranging the load carrying platform at the second drive module.

In an embodiment of the agricultural work vehicle according to the first aspect of the present invention the upper surface of said load carrying platform is being essentially planer.

In an embodiment of the agricultural work vehicle according to the first aspect of the present invention the upper surface of said load carrying platform is being essentially horizontally arranged at said drive module.

Hereby large items can easily be accommodated on the platform.

In an embodiment of the agricultural work vehicle according to the first aspect of the present invention, the load carrying platform and/or the chassis comprising said load carrying platform comprises one or more fastening means for fastening goods to be transported on said platform, such as in the form of hooks, rings or the like for fastening one or more straps.

In an embodiment of the agricultural work vehicle according to the first aspect of the present invention, the space above said load carrying platform is devoid of any parts relating to said agricultural work vehicle, thereby defining a free space above said load carrying platform.

In an embodiment of the agricultural work vehicle according to the first aspect of the present invention, an upper surface of said load carrying platform defines the highest surface of the drive module on which said load carrying platform is being arranged.

In an embodiment of the agricultural work vehicle according to the first aspect of the present invention the work vehicle further comprising an agricultural implement for performing an agricultural work operation.

In an embodiment of the agricultural work vehicle according to the first aspect of the present invention the agricultural implement is being selected from the group comprising: a tillage implement, a harrow, a seed drill, a cultivator, a weeder, a sprayer, a fertilizer spreader, an irrigator, a harvesting implement.

Hereby a vast array of various agricultural operations may be performed.

In an embodiment of the agricultural work vehicle according to the first aspect of the present invention the work vehicle further comprising a monitoring unit for monitoring the operation of said work vehicle.

Hereby can continuously be controlled whether or not the work vehicle and/or its attached implement operates is a desired mode.

In an embodiment of the agricultural work vehicle according to the first aspect of the present invention the control unit is being configured for receiving and storing information on a data storage, relating to one or more of the following: geographic coordinates relating to the boundary of an agricultural field to be worked; geographic coordinates relating to the boundary of one or more obstacles being present in an agricultural field to be worked; geographic coordinates relating to a preferred trajectory to be followed by said agricultural work vehicle; information relating to the effective working width of an agricultural implement to be carried/towed by said agricultural implement; information relating to the interrow distance between rows of crops in the agricultural field to be worked.

Hereby it is possible to instruct the work vehicle to follow a predetermined route on an agricultural field in a mode where the work vehicle operates in autonomously.

In an embodiment of the agricultural work vehicle according to the first aspect of the present invention the control unit comprises switching means for allowing an operator to switch between an autonomous working mode and/or a remotely controlled working mode and/or a semi-autonomous working mode of said agricultural work vehicle.

Hereby different modes of operations can be selected.

In an embodiment of the agricultural work vehicle according to the first aspect of the present invention the agricultural work vehicle comprises position indicating means, such as a GNSS (Global Navigation Satellite System) receiver, such as a GPS receiver for providing information relating to a geographical position of said vehicle.

In an embodiment of the agricultural work vehicle according to the first aspect of the present invention the control unit is configured to receive information from said position indicating means, relating to said geographical position of said work vehicle.

Hereby is assured that the control unit continuously gains information of the geographical position of the work vehicle.

In an embodiment of the agricultural work vehicle according to the first aspect of the present invention the control unit is being configured to provide instructions to said propulsion means and to said steering means of said work vehicle so as to make said work vehicle follow a desired trajectory on said agricultural field; wherein geographical coordinates of said desired trajectory is being or has been provided to said control unit.

Hereby an autonomous mode of operation is possible.

In an embodiment of the agricultural work vehicle according to the first aspect of the present invention the agricultural work vehicle comprises input means for programming said control unit, such as in the form of a receiver for wirelessly receiving information relating to a programming of said control unit.

Hereby the programming of the control system of the agricultural work vehicle can be performed conveniently.

In an embodiment of the agricultural work vehicle according to the first aspect of the present invention the agricultural work vehicle comprises a display, such as a monitor for displaying information relating to an operational state of said agricultural vehicle.

Hereby the operational state of the agricultural vehicle can be checked on site.

The Second Aspect of the Present Invention

In a second aspect the present invention relates to the use of an agricultural work vehicle according to the first aspect for performing an agricultural work operation.

In an embodiment of the use of the agricultural work vehicle according to the second aspect of the present invention the agricultural work operation is being selected from the group comprising: surveying of the agricultural field, tillaging soil, harrowing soil, seeding seeds into soil, cultivation of soil, weeding of soil, spraying, such as spraying of a herbicide or of a pesticide or of a fungicide, spreading of fertilizer, irrigation of the field with water, harvesting crops.

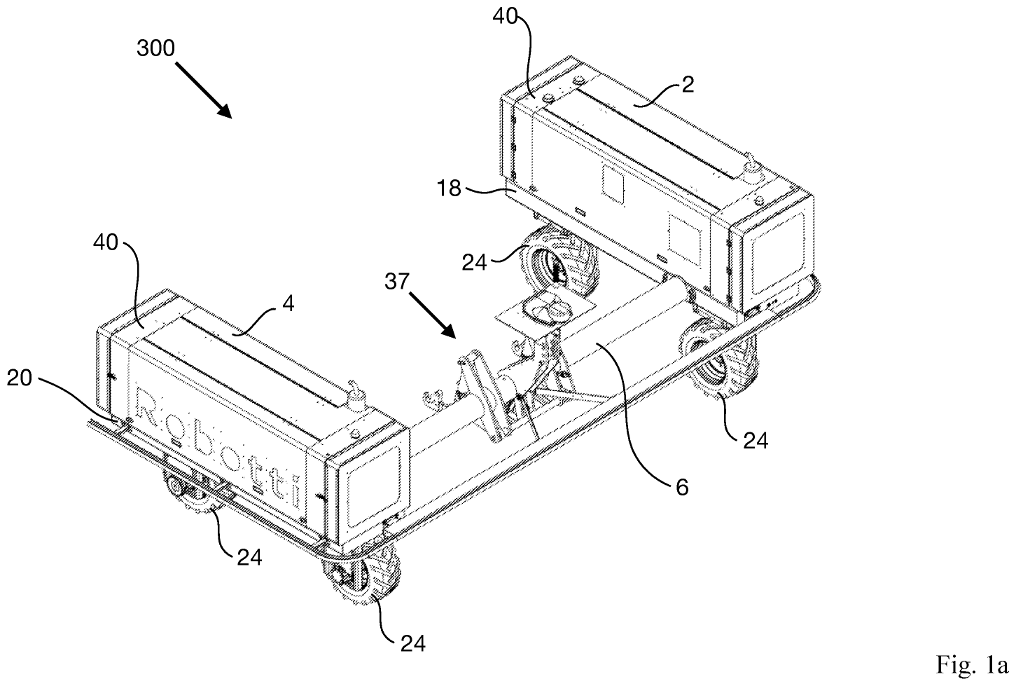

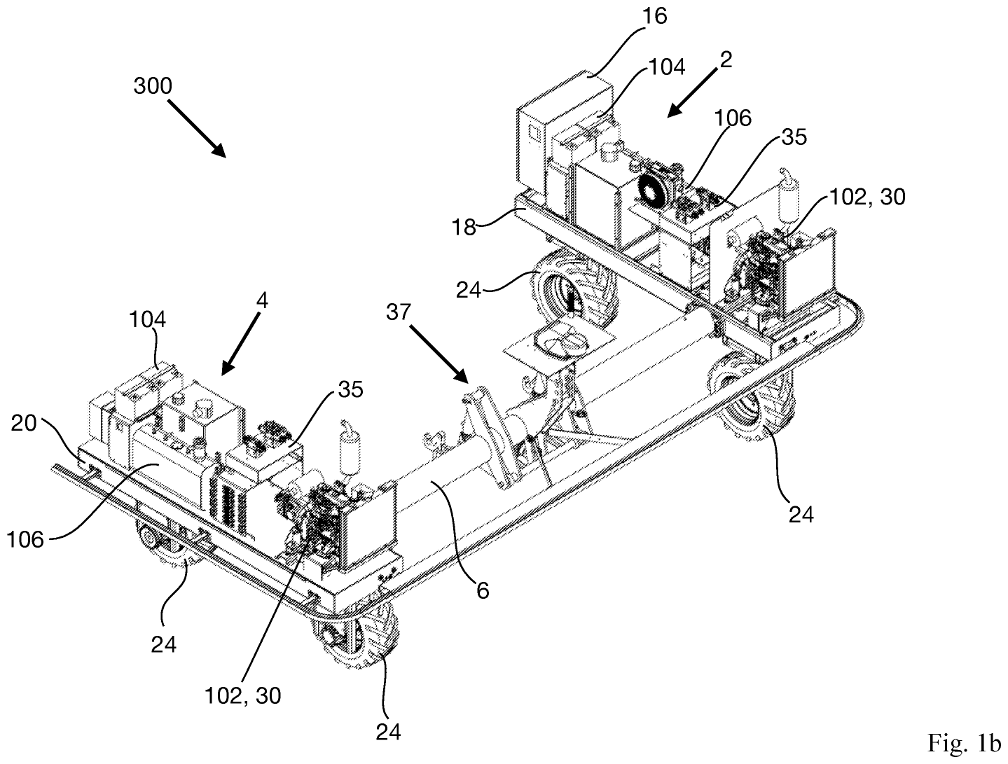

Referring now to the drawings for better illustrating the present invention, FIG. 1a is a perspective view illustrating an autonomous agricultural work vehicle according to the prior art. The agricultural work vehicle illustrated in FIG. 1 is the autonomous agricultural work vehicle marketed as Robotti and which has been mentioned in the introduction of this patent application.

FIG. 1a shows the prior art autonomous agricultural work vehicle 300 comprising a first drive module 2 and a second drive module 4. Each drive module comprises two wheels 24.

It is seen that the first drive module 2 is connected to the second drive module 4 by a connecting element 6 having a fixed axial extension. The connecting element 6 carries coupling means 37 in the form of a three-point hitch for coupling an agricultural implement to the vehicle. The connecting element 6 is being rigidly fastened to the first module 2 at a first chassis 18 thereof. Likewise, the connecting element 6 is being rigidly fastened to the second module 4 at a second chassis 20 thereof.

FIG. 1b is a perspective view illustrating an agricultural work vehicle according to the prior art, with its covers 40 removed.

FIG. 1b shows that each drive module 2,4 under their respective covers 40 are filled with mechanical, electronic and hydraulic technology for propelling, steering and operating the agricultural work vehicle.

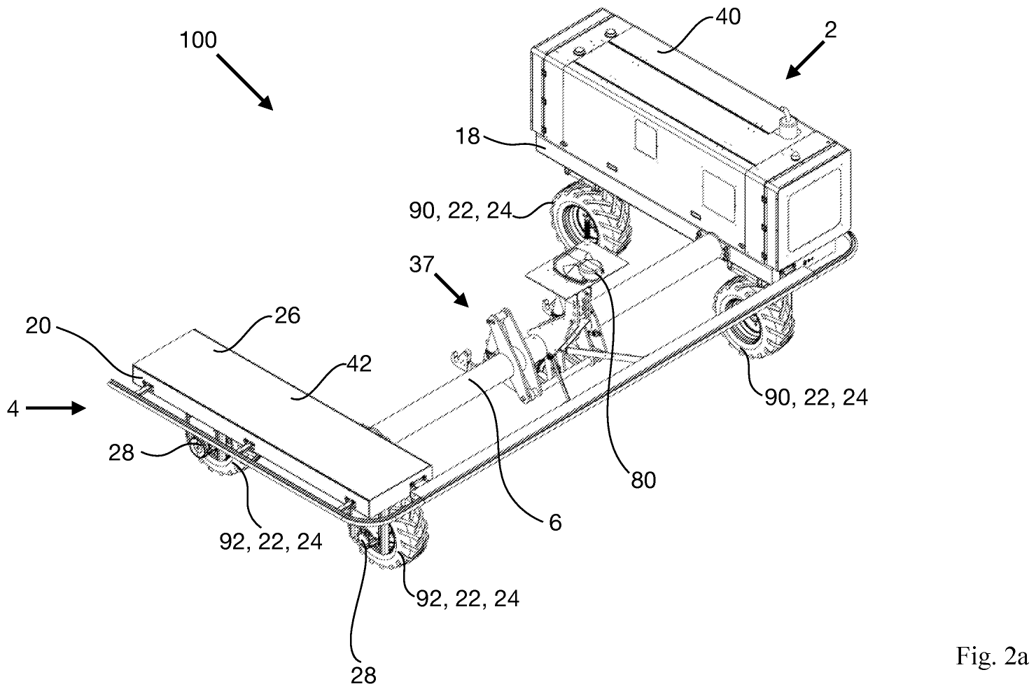

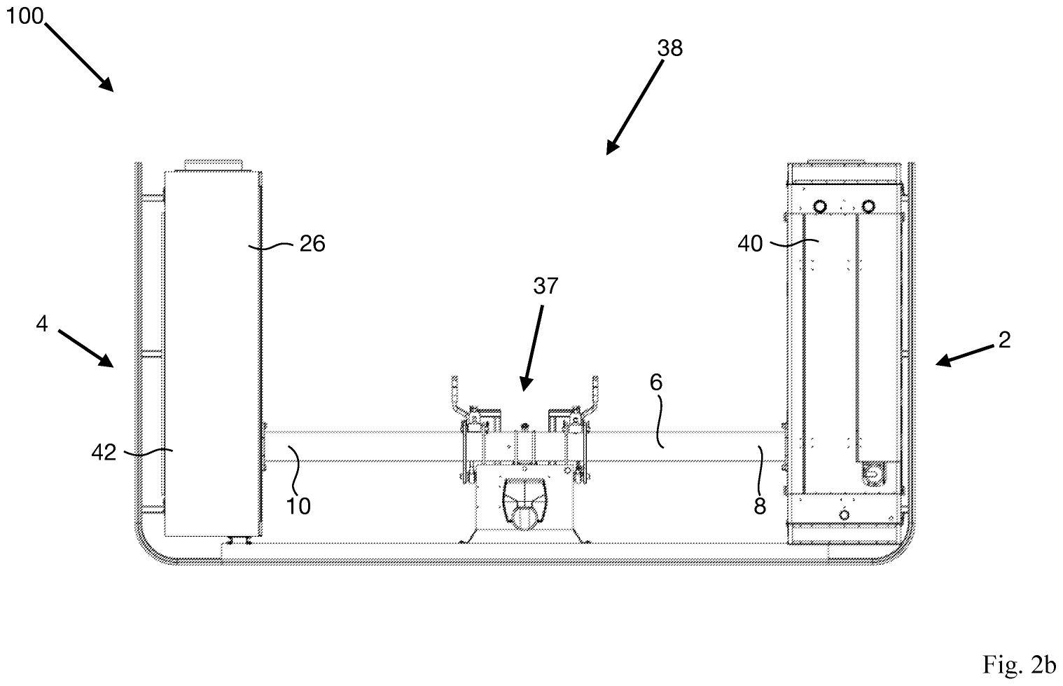

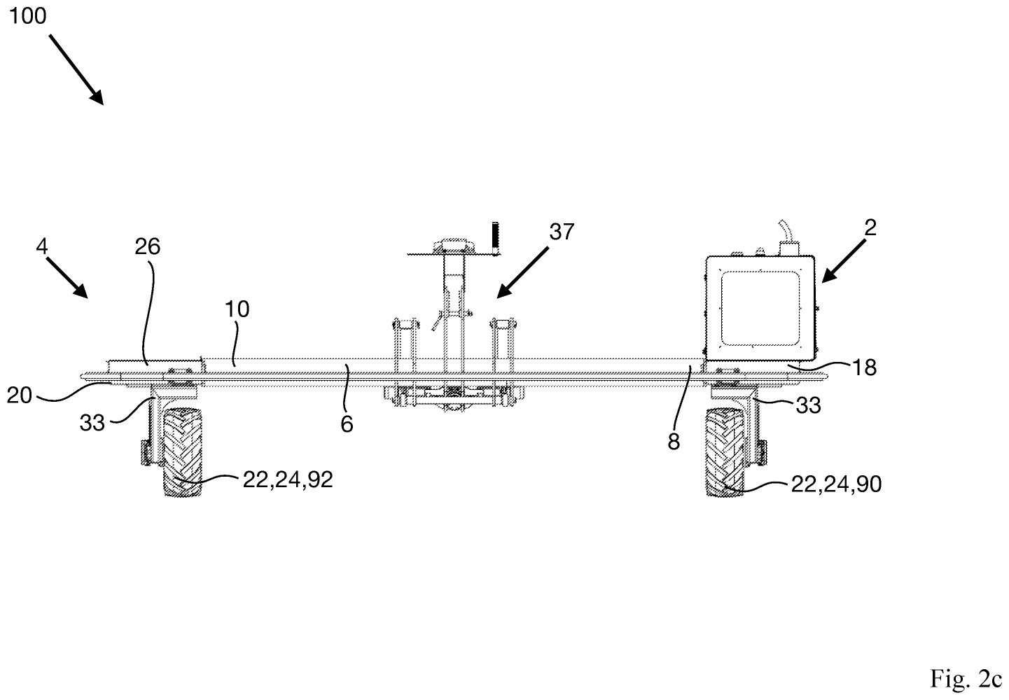

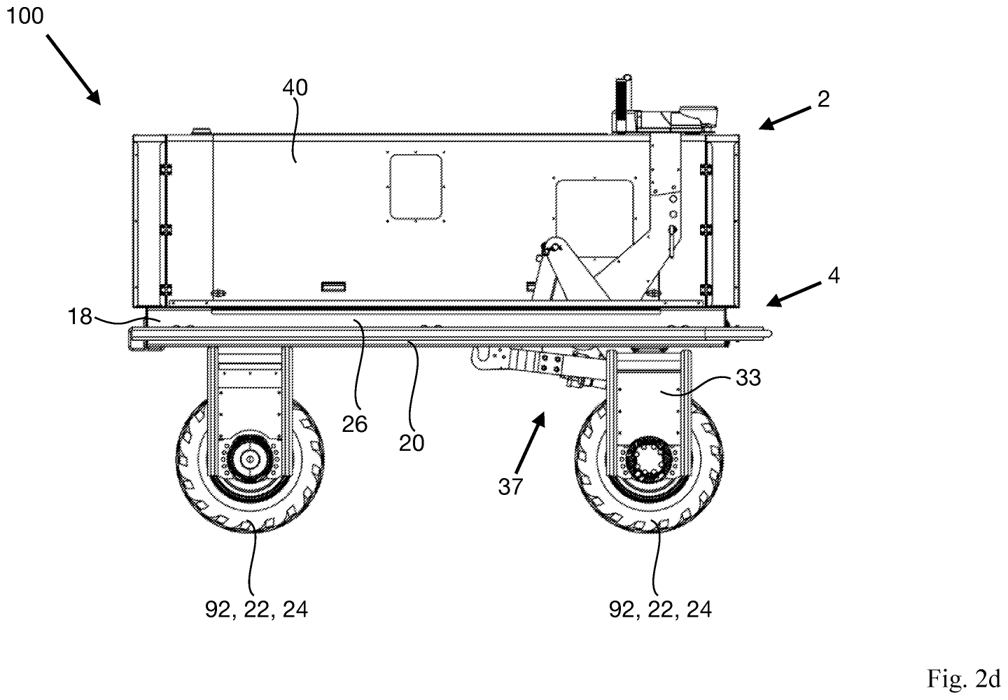

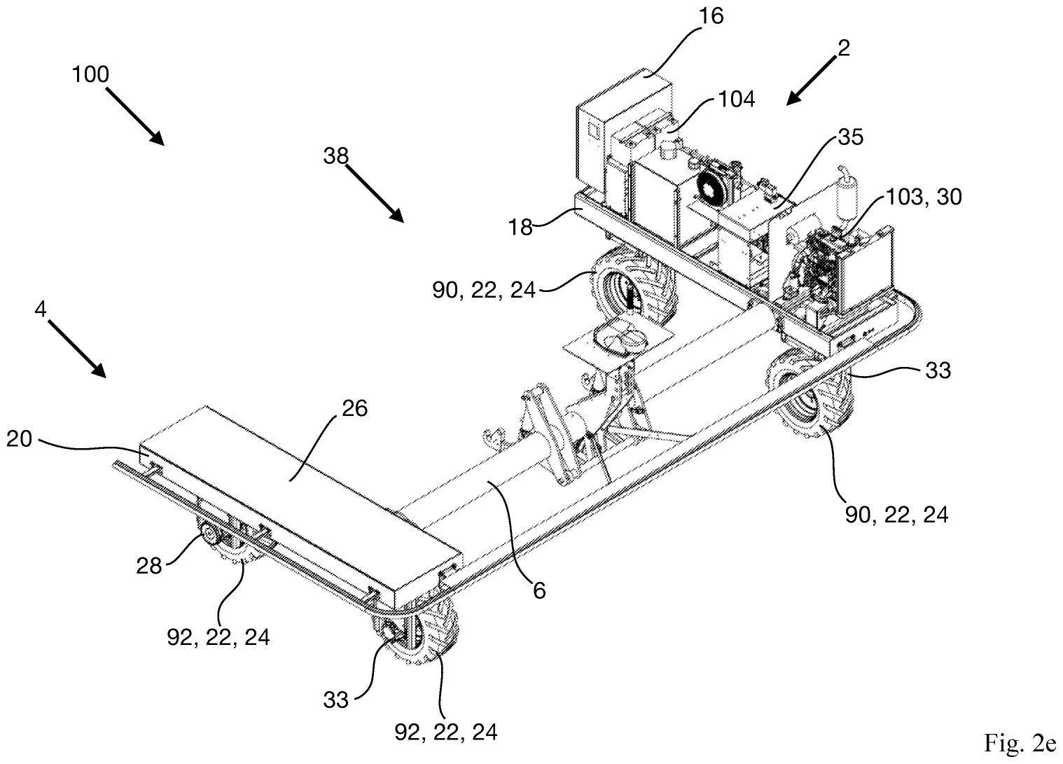

Accordingly, it is seen in FIG. 1b that each drive unit 2,4 of the prior art Robotti vehicle 300 comprises its own diesel engine 102 for providing power for propelling the work vehicle. A hydraulic pump 30 is integrated with each engine. Associated herewith are also provided a diesel tank 106 and a battery 104. Hydraulic valves 35 controls the actuation of hydraulic actuation means 34 for steering the work vehicle. A control unit 16 is also seen in FIG. 2e.

As both drive modules 2,4 of the prior art work vehicle are compacted with equipment there is no room for providing any of the drive modules 2,4 with a load carrying platform.

FIG. 2a is a perspective view of an agricultural work vehicle 100 according to the present invention. The work vehicle 100 comprising a first drive module 2 and a second drive module 4. Each drive module comprises two drive means 90,92 in the form of wheels 24.

Again, it is seen that the first drive module 2 is connected to the second drive module 4 by a connecting element 6. The connecting element 6 carries coupling means 37 in the form of a three-point hiss for coupling an agricultural implement to the vehicle.

The inventive work vehicle 100 is provided with a load carrying platform 26 at the second drive module 4. The load carrying module 26 is integrated with the chassis 20 of the second drive module and it comprises an upper surface 42. It is seen that the load carrying platform 26 is arranged above the wheels 24 of the second drive module 4.

As it will be revealed in FIG. 2e most of the technology necessary to propel and operate the inventive work vehicle 100 illustrated in FIG. 2a is located under the cover 40 of the first drive module 2.

FIG. 2b is a top view illustrating the agricultural work vehicle shown in FIG. 2a and FIG. 2c is a front view thereof. FIG. 2b points out that a free space 38 is provided between the first drive module 2 and the second drive module 4. FIGS. 2b and 2c show that the connecting element 6 comprises a first axial end 8 and a second axial end 10.

FIG. 2c shows that the two front wheels 24 of the drive means 90,92 are suspended in a wheel base 33, each of which allows the alternation of the pitch of the rotational plane of each wheel, relative to a fixed geographical direction.

FIG. 2d is a side view of the inventive agricultural work vehicle illustrated in FIG. 2a as seen from the right side, relative to the second drive module 4.

FIG. 2e is a perspective view illustrating the inventive agricultural work vehicle of FIG. 2a with the cover 40 of the first drive module 2 removed, thereby exposing details of the mechanics and hydraulics involved in the operation of the vehicle.

FIG. 2e shows that only drive unit 2 comprises a diesel engine 102 for providing power for propelling the work vehicle. A hydraulic pump 30 is integrated with the engine. Associated herewith are also provided a diesel tank 106 and a battery 104.

Hydraulic valves 35 controls the actuation of hydraulic actuation means 34 for steering the work vehicle. A control unit 16 is also seen in FIG. 2e.

Although the first drive module 2 comprises most of the equipment for providing power to and for operating the inventive work vehicle 100, hydraulic hoses are provided to the hydraulic drive 28 and to the actuator 34 for controlling the wheel base 33 in respect of both drive modules (not seen in FIG. 2e).

By concentrating most of the equipment necessary to operate the work vehicle 100 at the first drive module 2 it is possible to provide adequate space at the second drive module 4 allowing providing this module 4 with the load carrying platform 26, while still providing full operational control of the first drive module 2 as well as the second drive module 4.

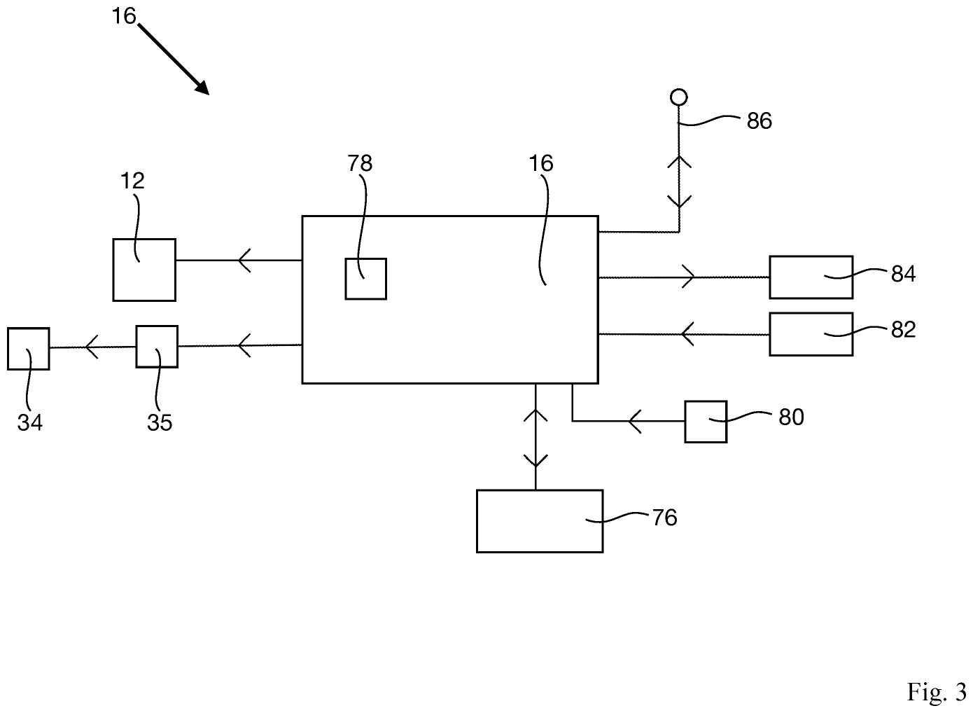

FIG. 3 is a diagrammatic illustration illustrating the working mode of the control unit of the agricultural working unit of the present invention.

FIG. 3 shows that control unit 16 which is being connected to an input means 82. The input means allows for programming or setting the desired operation of the agricultural work vehicle 100. A display 84 allows for monitoring the setting and the operational state of the agricultural work vehicle. Alternative to the input means 82 the control unit may also be programmed or may receive information relating to desired settings by means of the receiver 86 for receiving electromagnetic signals.

FIG. 3 also shows that the control unit is coupled to a position indicating receiver 80 which is configured for providing to the control unit information relating to a current geographical position of the agricultural work vehicle 100. A data storage 76 is provided for storing data relating to the operation of the agricultural vehicle, such as data relating to geographical coordinates of a desired trajectory to be followed during working of an agricultural field.

A switch 78 is provided for allowing switching the operational mode between an autonomous working mode, a manually controlled working mode, such as a remotely controlled mode or a semi-autonomous working mode. The switch 78 may also be actuated wirelessly by means of the receiver 86.

The control unit 16 is configured for providing signals to the propulsion means 12 relating to controlling the propulsion of the vehicle.

Moreover, the control unit 16 is configured for providing signals to a hydraulic valve 35 which in turn provides for supplying hydraulic fluid to the hydraulic actuator 34 which is responsible for actuating the wheel bases 33 so as to turn these with the view to steer the agricultural work vehicle.

Accordingly, in an autonomous working mode, the control unit has been supplied, via the input means 82 or the receiver 86, with information relating to a desired trajectory to be followed by the working vehicle when working an agricultural field. The position indicating means 80 will constant provide information to the control unit relating to the geographical position of the work vehicle. Based on this information and based on the desired trajectory to be followed, the control unit will constantly provide propulsion information and steering information, respectively, to the propulsion means 12 and to the hydraulic valve 35, respectively, with the view to safely and efficiently make the agricultural work vehicle follow a desired path on the agricultural field during working thereof.

It should be understood that all features and achievements discussed above and in the appended claims in relation to one aspect of the present invention and embodiments thereof apply equally well to the other aspects of the present invention and embodiments thereof.

### LIST OF REFERENCE NUMERALS

2 First drive module
4 Second drive module
6 Connecting element
8 First axial end of connecting element
10 Second axial end of connecting element
12 Propulsion means
14 Steering means
16 Control unit
18 First chassis
20 Second chassis
22 Set of wheels
24 Wheel
26 Load carrying platform
28 Hydraulic drive
30 Hydraulic pump
32 Motor for driving hydraulic pump
33 Wheel base
34 Actuation means of steering means
35 Hydraulic valve
36 Energy storage or energy provider
37 Coupling means
38 Free space
40 Cover of drive module
42 Upper surface of load carrying platform
76 Data storage
78 Switching means
80 Position indicating means
82 Input means
84 Display
86 Receiver for electromagnetic signals
90, 92 Drive means
100 Agricultural work vehicle according to the invention
102 Diesel engine
104 Battery
106 Diesel tank
300 Prior art agricultural work vehicle

The invention of the present patent application may be defined according to the following clause 1-50:

Clause 1: An agricultural work vehicle (100) for performing an agricultural work operation in an agricultural field, wherein said work vehicle comprises:
a first drive module (2);
a second drive module (4);
a connecting element (6); said connecting element comprises a first axial end (8) and a second axial end (10);
propulsion means (12) for propelling said work vehicle;
steering means (14) for steering said work vehicle;
a control unit (16) for controlling the operation of said work vehicle;

wherein said first drive module (2) comprises a first chassis (18);

wherein said second drive module (4) comprises a second chassis (20);

wherein said first drive module (2) comprises drive means (90) for allowing said first drive module to move over ground, said drive means (90) being suspended on said first chassis (18);

wherein said second drive module comprises drive means (92) for allowing said second drive module to move over ground, said drive means (92) being suspended on said second chassis (20);

wherein said first axial end (8) of said connecting element (6) is being attached to said first chassis (18); and wherein said second axial end (10) of said connecting element (6) is being connected to said second chassis (20);

wherein one of said two drive modules (2,4) comprises a load carrying platform (26) arranged at the corresponding chassis (18,20).

Clause 2: An agricultural work vehicle (100) according to clause 1, wherein said agricultural work vehicle is being a remotely controlled work vehicle and/or an autonomous work vehicle and/or a semi-autonomous work vehicle.

Clause 3: An agricultural work vehicle (100) according to clause 1 or 2, wherein said propulsion means (12) comprises one or more electric motors or one or more hydraulic drives (28) or one or more mechanical drives for driving said drive means (90,92).

Clause 4: An agricultural work vehicle (100) according to any of the preceding clauses, wherein said drive means (90,92) each comprises two or more sets of wheels, wherein all wheels in a specific set of wheels are sharing a common axis of rotation; and/or wherein said drive means (90,92) comprises one or two or more caterpillar belts.

Clause 5: An agricultural work vehicle (100) according to clause 4, wherein said drive means (90,92) each comprises two sets (22) of wheels (24), said sets (22) of wheels (24) being arranged behind each other, as seen relative to a non-turning direction of movement of said vehicle.

Clause 6: An agricultural work vehicle (100) according to clause 5, wherein in respect of a specific set (22) of wheels (24), said set of wheel comprises one, two, three, or four or more wheels (24).

Clause 7: An agricultural work vehicle (100) according to clause 4, wherein said drive means (90,92) comprises one, two, three, or four or more caterpillar belts, optionally being arranged sideways to each other and/or behind each other.

Clause 8: An agricultural work vehicle (100) according to any of the clauses 5-7, wherein said propulsion means are configured for driving one or two sets (22) of wheels (24) or caterpillar belts of each drive module (2,4).

Clause 9: An agricultural work vehicle (100) according to any of the clauses 1-8, wherein said propulsion means (12) comprises hydraulic drives for driving said drive means (90,92) and wherein said agricultural work vehicle comprises one or more hydraulic pumps (30) for driving said hydraulic drives (28), wherein said agricultural work vehicle furthermore comprises a motor (32) for driving said hydraulic pump (30), such as an electric motor; or a combustion engine, such as a petrol engine or a diesel engine, or a biogas engine.

Clause 10: An agricultural work vehicle (100) according to any of the clauses 1-8, wherein said propulsion means (12) comprises an electric motor for driving said drive means (90,92).

Clause 11: An agricultural work vehicle (100) according to any of the clauses 1-8, wherein said propulsion means (12) comprises mechanical means for driving said drive means (90,92).

Clause 12: An agricultural work vehicle (100) according to any of the preceding clauses, wherein one or more of said wheels (24) independently is/are having an outer diameter of 25-300 cm, such as 30-275 cm, for example 35-250 cm, such as 40-225 cm, e.g. 45-200 cm, such as 50-175 cm, e.g. 55-150 cm, such as 60-125 cm, e.g. 65-100 cm, such as 70-95 cm, such as 75-90 cm, e.g. 80-85 cm.

Clause 13: An agricultural work vehicle (100) according to any of the preceding clauses wherein at least one set (22) of wheels (24) of each drive module (2,4) is being pivotally suspended in a wheel base (34) on its corresponding chassis (18,20) in such a way that the pitch of the rotational plane of said one or more wheels (24) of said set (22) of wheels can be altered, relative to a fixed geographical direction, and wherein said steering means (14) comprises actuation means (34) for altering said pitch.

Clause 14: An agricultural work vehicle (100) according to any of the preceding clauses, wherein said steering means (14) comprises means for allowing propelled wheels (24) of one drive module (2,4) to rotate at a rotational speed which is different from the rotational speed of the propelled wheels (24) of the other drive module (4,2).

Clause 15: An agricultural work vehicle (100) according to any of the preceding clauses, wherein the shortest distance from the center of a wheel (24) of one drive module (2,4) to the center of a wheel (24) of the other drive module (4,2) is selected from the range 20-4000 cm, such as 30-3500 cm, e.g. 40-3000 cm, such as 50-2500 cm, for example 60-2000 cm, e.g. 70-1800 cm, such as 80-1700 cm, e.g. 90-1600 cm, for example 100-1500 cm, e.g. 150-1400 cm, e.g. 200-1300 cm, such as 250-1200 cm, such as 300-1100 cm, such as 350-1000 cm, such as 400-900 cm, such as 500-800 cm, e.g. 600-700 cm.

Clause 16. An agricultural work vehicle (100) according to any of the preceding clauses comprising an energy storage or energy provider (36), such as a fuel tank or a battery; or one or more solar panels; or one or more fuel cell modules in combination with a fuel gas tank, such as a hydrogen tank or a methane tank.

Clause 17: An agricultural work vehicle (100) according to any of the preceding clauses further comprising coupling means (38) for allowing coupling to said agricultural work vehicle of an agricultural implement, said coupling means (37) optionally being arranged at or on said connecting element (6), said coupling means optionally being in the form of a three-point hitch or in the form of an A frame.

Clause 18: An agricultural work vehicle (100) according to any of the preceding clauses, wherein said first drive module (2) and said second drive module (4) are having an elongate shape.

Clause 19: An agricultural work vehicle (100) according to any of the preceding clauses, wherein said first axial end (8) of said connecting element (6) is attached to said first chassis (18) of said first drive module (2) at an end thereof; and wherein said second axial end (10) of said connecting element (6) is attached to said second chassis (20) of said second drive module (4) at an end thereof.

Clause 20: An agricultural work vehicle (100) according to any of the preceding clauses, wherein said first drive module (2) and said second drive module (4) are arranged essentially in a parallel orientation relative to each other.

Clause 21: An agricultural work vehicle (100) according to any of the preceding clauses, wherein said first drive module (2) and said second drive module (4) are arranged relative to each other in such a way that a free space (38) is being present between part of said first drive module (2) and part of said second drive module (4).

Clause 22: An agricultural work vehicle (100) according to clause 21, wherein the free space (38) between the first drive module (2) and the second drive module (4) in a region appearing in a direction perpendicular to the connecting element (6), such as in a forward pointing direction and/or in a rearward pointing direction, is devoid from any element connecting said first drive module (2) to said second drive module (4).

Clause 23: An agricultural work vehicle (100) according to any of the preceding clauses wherein each drive means (90,92) is being rigidly suspended at or on its corresponding chassis (18,20), i.e. in a non-spring-loaded manner.

Clause 24: An agricultural work vehicle (100) according to any of the preceding clauses wherein said work vehicle comprises a monitoring unit for visually monitoring soil and/or vegetation during operation thereof.

Clause 25: An agricultural work vehicle (100) according to any of the preceding clauses wherein said work vehicle comprises means for allowing, during driving a curved trajectory, the outer drive means, such as the outer wheels, to rotate a higher angular velocity, compared to the inner drive means, such as the inner wheels.

Clause 26: An agricultural work vehicle (100) according to any of the preceding clauses wherein the part of the propulsion means (12) providing the power for propelling said agricultural work vehicle is being solely arranged on said first drive module (2).

Clause 27: An agricultural work vehicle (100) according to any of the preceding clauses wherein said control unit (16) is being solely arranged at said first drive module (2).

Clause 28: An agricultural work vehicle (100) according to any of the preceding clauses, wherein any energy storage or energy provider (36), such as a fuel tank or a battery; or one or more solar panels; or one or more fuel cell modules in combination with a fuel gas tank, such as a hydrogen tank or a methane tank, is/are being solely arranged at said first drive module (2).

Clause 29: An agricultural work vehicle (100) according to any of the preceding clauses, wherein said load carrying platform (26) defines an upper surface (42) having an extension in a longitudinal direction of 100-4000 cm, such as 150-3500 cm, e.g. 200-3000 cm, for example 250-2500 cm, such as 300-2000 cm, e.g. 400-1500 cm, e.g. 500-1000 cm.

Clause 30: An agricultural work vehicle (100) according to any of the preceding clauses, wherein said load carrying platform (26) defines an upper surface (42) having an extension in a transverse direction of 25-1500 cm, such as 50-1200 cm, e.g. 100-1000 cm, such as 150-800 cm, e.g. 200-700 cm, such as 300-600 cm or 400-500 cm.

Clause 31: An agricultural work vehicle (100) according to any of the preceding clauses, wherein said load carrying platform (26) defines an upper surface (42) which is being arranged at a level above ground of 20-200 cm, such as 25-175 cm, e.g. 50-150 cm, such as 75-125 cm.

Clause 32: An agricultural work vehicle (100) according to any of the preceding clauses, wherein said load carrying platform (26) is being arranged at a level above said drive means (92) of said second drive module (4).

Clause 33: An agricultural work vehicle (100) according to any of the preceding clauses, wherein said load carrying platform (26) is being arranged above said second chassis (20) of the second drive module (4); or wherein said load carrying platform (26) is integrated with said second chassis (20) of said second drive module (4).

Clause 34: An agricultural work vehicle (100) according to any of the preceding clauses, wherein said load carrying platform (26) defines an upper surface (42) having a rectangular shape.

Clause 35: An agricultural work vehicle (100) according to any of the preceding clauses, wherein said load carrying platform (26) comprises one or more essentially vertical sides, such as detachable sides, for securing goods being arranged on said platform.

Clause 36: An agricultural work vehicle (100) according to any of the preceding clauses, wherein the second drive module (4) is devoid of any of the following: part of the propulsion means (12) providing the power for propelling said agricultural work vehicle; said control unit (16); any energy storage or energy provider (36), such as a fuel tank or a battery; or one or more solar panels; or one or more fuel cell modules in combination with a fuel gas tank, such as a hydrogen tank or a methane tank.

Clause 37: An agricultural work vehicle (100) according to any of the preceding clauses, wherein said upper surface (42) of said load carrying platform (26) is being essentially planer.

Clause 38: An agricultural work vehicle (100) according to any of the preceding clauses, wherein said upper surface (42) of said load carrying platform (26) is being essentially horizontally arranged at said drive module (2,4).

Clause 39: An agricultural work vehicle (100) according to any of the preceding clauses further comprising an agricultural implement for performing an agricultural work operation.

Clause 40: An agricultural work vehicle (100) according to clause 39, wherein said agricultural implement is being selected from the group comprising: a tillage implement, a harrow, a seed drill, a cultivator, a weeder, a sprayer, a spreader, an irrigator, a harvesting implement.

Clause 41: An agricultural work vehicle (100) according to any of the preceding clauses further comprising a monitoring unit for monitoring the operation of said work vehicle.

Clause 42: An agricultural work vehicle (100) according to any of the preceding clauses wherein said control unit (16) is being configured for receiving and storing information on a data storage (76), relating to one or more of the following: geographic coordinates relating to the boundary of an agricultural field to be worked; geographic coordinates relating to the boundary of one or more obstacles being present in an agricultural field to be worked; geographic coordinates relating to a preferred trajectory to be followed by said agricultural work vehicle; information relating to the effective working width of an agricultural implement to be carried/towed by said agricultural implement.

Clause 43: An agricultural work vehicle (100) according to any of the preceding clauses, wherein said control unit (16) comprises switching means (78) for allowing an operator to switch between an autonomous working mode and/or a remotely controlled working mode and/or a semi-autonomous working mode of said agricultural work vehicle (100).

Clause 44: An agricultural work vehicle (100) according to any of the preceding clauses, wherein said agricultural work vehicle comprises position indicating means (80), such as a GNSS (Global Navigation Satellite System) receiver, such as a GPS receiver for providing information relating to a geographical position of said vehicle.

Clause 45: An agricultural work vehicle (100) according to clause 44, wherein said control unit (16) is configured to receive information from said position indicating means (80), relating to said geographical position of said work vehicle.

Clause 46: An agricultural work vehicle (100) according to any of the clauses 42-45, wherein said control unit (16) is being configured to provide instructions to said propulsion means (12) and to said steering means (14) of said work vehicle so as to make said work vehicle follow a desired trajectory on said agricultural field; wherein geographical coordinates of said desired trajectory is being or has been provided to said control unit (16).

Clause 47: An agricultural work vehicle (100) according to any of the preceding clauses wherein said agricultural work vehicle comprises input means (82) for programming said control unit (16), such as in the form of a receiver for wirelessly receiving information relating to a programming of said control unit.

Clause 48: An agricultural work vehicle (100) according to any of the preceding clauses wherein said agricultural work vehicle comprises a display (84), such as a monitor for displaying information relating to an operational state of said agricultural vehicle.

Clause 49: Use of an agricultural work vehicle (100) according to any of preceding clauses for performing an agricultural work operation.

Clause 50: Use according to clause 49, wherein said agricultural work operation is being selected from the group comprising: surveying of the agricultural field, tillaging soil, harrowing soil, seeding seeds into soil, cultivation of soil, weeding of soil, spraying, such as spraying of a herbicide or of a pesticide or of a fungicide, spreading of fertilizer, irrigation of the field with water, harvesting crops.

1-47. (canceled)

48. An agricultural work vehicle (100) for performing an agricultural work operation in an agricultural field, wherein the work vehicle comprises:
a first drive module (2) comprising a first chassis (18) and a first drive means (90) suspended on the first chassis for allowing the first drive module to move over ground;
a second drive module (4) comprising a second chassis (20) and a second drive means (92) suspended on the second chassis for allowing the second drive module to move over ground;
a connecting element (6) comprising a first axial end (8) attached to the first chassis at end thereof and a second axial end (10) attached to the second chassis (20) at end thereof;
a propulsion means (12) for propelling the work vehicle;
steering means (14) for steering the work vehicle; and
a control unit (16) for controlling the operation of the work vehicle, wherein
one of the two drive modules (2, 4) comprises a load carrying platform (26) arranged at the corresponding chassis (18, 20),
the agricultural work vehicle (100) is an autonomous work vehicle,
the load carrying platform (26) is integrated with the second chassis (20) of the second drive module (4), and
the part of the propulsion means (12) providing the power for propelling the agricultural work vehicle is arranged solely on the first drive module (2).

49. The agricultural work vehicle (100) of claim 48, wherein each of the drive means (90, 92) comprises two or more sets of wheels, wherein all wheels within a specific set of wheels share a common axis of rotation and/or the drive means comprises one or more caterpillar belts.

50. The agricultural work vehicle (100) of claim 49, wherein each of the drive means (90, 92) comprises two sets (22) of wheels (24), the sets being arranged behind each other relative to a non-turning direction of movement of the vehicle.

51. The agricultural work vehicle (100) of claim 50, wherein the drive means (90, 92) comprises one or more caterpillar belts arranged sideways to each other and/or behind each other.

52. The agricultural work vehicle (100) of claim 48 wherein
at least one set (22) of wheels (24) of each drive module (2, 4) is pivotally suspended in a wheel base (34) on its corresponding chassis (18, 20) in such a way that a pitch of rotational plane of the one or more wheels (24) is alterable relative to a fixed geographical direction, and the steering means (14) comprises:
an actuation means (34) for altering the pitch and/or
means for allowing propelled wheels (24) of one drive module (2, 4) to rotate at a rotational speed which is different from the rotational speed of the propelled wheels (24) of the other drive module (4, 2).

53. The agricultural work vehicle (100) of claim 48 further comprising:
coupling means (37) for coupling am agricultural implement to the agricultural work vehicle, the coupling means (37) being arranged at or on the connecting element (6), the coupling means being in the form of a three-point hitch or in the form of an A frame.

54. The agricultural work vehicle (100) of claim 48, wherein the first drive module (2) and the second drive module (4) have an elongate shape wherein the first drive module (2) and the second drive module (4) are arranged in a parallel orientation relative to each other.

55. The agricultural work vehicle (100) of claim 48, wherein the first drive module (2) and the second drive module (4) are arranged relative to each other to create a free space (38) between part of the first drive module (2) and part of the second drive module (4), the free space (38) is in a region in a direction perpendicular to the connecting element (6), such as in a forward pointing direction and/or in a rearward pointing direction and is devoid from any element connecting the first drive module (2) to the second drive module (4).

56. The agricultural work vehicle (100) of claim 48 wherein the work vehicle comprises at least one:
a monitoring unit for visually monitoring soil and/or vegetation during operation,
means for allowing, during driving a curved trajectory, the outer drive means, such as the outer wheels, to rotate a higher angular velocity, compared to the inner drive means, such as the inner wheels;
input means (82) for programming the control unit (16), such as in the form of a receiver for wirelessly receiving information relating to a programming of the control unit; and
a display (84), such as a monitor for displaying information relating to an operational state of the agricultural vehicle.

57. The agricultural work vehicle (100) of claim 48 wherein the control unit (16) is arranged solely at the first drive module (2).

58. The agricultural work vehicle (100) of claim 48, wherein an energy source (36) is arranged solely at the first drive module (2), the energy source being:
a fuel tank, a battery, one or more solar panels, one or more fuel cell modules in combination with a fuel gas tank, the gas tank being a hydrogen tank and/or a methane tank.

59. The agricultural work vehicle (100) of claim 48, wherein the load carrying platform (26) is arranged at a level above the drive means (92) of the second drive module (4) or above the second chassis (20) of the second drive module (4), the load carrying platform (26) defining an upper surface (42) having a rectangular shape and comprising one or more detachable, vertical sides for securing goods being arranged on the platform; the upper surface being planar or being arranged horizontally at the drive module (2,4).

60. The agricultural work vehicle (100) of claim 48, wherein the second drive module (4) is devoid of any one of: a part of the propulsion means (12) providing power for propelling the agricultural work vehicle; the control unit (16); energy storage or energy provider (36) such as a fuel tank or a battery; or one or more solar panels; or one or more fuel cell modules in combination with a fuel gas tank, such as a hydrogen tank or a methane tank.

61. The agricultural work vehicle (100) of claim 48 further comprising an agricultural implement for performing an agricultural work operation, the agricultural implement being one of: a tillage implement, a harrow, a seed drill, a cultivator, a weeder, a sprayer, a spreader, an irrigator and a harvesting implement.

62. The agricultural work vehicle (100) of claim 48 further comprising a monitoring unit for monitoring the operation of the work vehicle.

63. The agricultural work vehicle (100) of claim 48 wherein the control unit (16) is configured for receiving and storing information on a data storage (76), the information relating to one or more of: geographic coordinates relating to a boundary of an agricultural field to be worked; geographic coordinates relating to the boundary of one or more obstacles in an agricultural field to be worked; geographic coordinates relating to a preferred trajectory to be followed by the agricultural work vehicle; information relating to an effective working width of an agricultural implement to be carried or towed by the agricultural implement.

64. The agricultural work vehicle (100) of claim 48, wherein the control unit (16) comprises switching means (78) for allowing an operator to switch between an autonomous working mode, a remotely controlled working mode and a semi-autonomous working mode of the agricultural work vehicle (100).

65. The agricultural work vehicle (100) of claim 48, wherein the agricultural work vehicle comprises position indicating means (80), such as a GNSS (Global Navigation Satellite System) receiver, such as a GPS receiver for providing information relating to a geographical position of the vehicle wherein the control unit (16) is configured to receive information from the position indicating means (80), relating to the geographical position of the work vehicle.

66. The agricultural work vehicle (100) of claim 48, wherein the control unit (16) is configured to provide instructions to the propulsion means (12) and to the steering means (14) of the work vehicle for the work vehicle to follow a desired trajectory on the agricultural field wherein geographical coordinates of the desired trajectory is being provided to the control unit (16).

67. Use of an agricultural work vehicle (100) according to claim 48 for performing an agricultural work operation.
